(19) United States
(12) Patent Application Publication
(10) Pub. No.: US 2004/0083115 A1
(43) Pub. Date: Apr. 29, 2004

(54) Methods for improving business decisions

(76) Inventors: Donna Hodges, Cumming, GA (US); Jai Menon, Alpharetta, GA (US); John Sess, Woodstock, GA (US)

Correspondence Address: IP GROUP, SHAW PITTMAN/BELLSOUTH CORPORATION, 1650 TYSON BOULEVARD, MCLEAN, VA, 22102, US

(21) Appl. No.: 10/336,696

(22) Filed: Jan. 6, 2003

Related U.S. Application Data
(60) Provisional application No. 60/344,806, filed on Jan. 7, 2002.

(51) Int. Cl. G06F 17/60

(52) U.S. Cl. 705/1

(57) ABSTRACT

A procedure for increasing the efficiency of the implementation of a solution to a business problem is presented. In such a procedure a soliciting business that has a given problem seeks solutions from other businesses that have a close relationship to the soliciting business. Such other businesses are motivated to provide specialized solutions in a timely manner and at a potential lower cost than that which would have been received if the soliciting business had used a standard request for business procedure.

This application claims the benefit of U.S. Provisional Application No. 60/344,806, filed Jan. 7, 2002, which is incorporated by reference herein in its entirety.

### BACKGROUND

1. Field of the Invention

The present invention relates generally to methods for improving business processes. More particularly, the present invention relates to improving communications between a soliciting business and various vendors in order to improve business decisions.

2. Background of the Invention

Businesses have long used various conventional means to solicit information, estimates, quotes, and contracts from other businesses. Such conventional means include, for example, requests for information (“RFI”), requests for proposals (“RFP”), and requests for quotes (“RFQ”). Such requests for various services, herein collectively represented as “RFx”, have been used to assist a given business in analyzing, evaluating, soliciting, planning, and completing business projects.

The typical RFx procedure used, for example, to solicit proposals for goods and/or services, is highly structured. This procedure is necessarily very formal and rigid to ensure certainty and repeatability. Further, the RFx procedure should be conducted objectively and fairly to ensure that all potential vendors that may offer goods and/or services to a soliciting business have an equal opportunity to fairly present their proposals to the soliciting business without knowledge of the proposals of other vendors. Thus, each vendor should be given an equal chance to bid and compete for a particular project offered by a soliciting business.

Further, because of the nature of the RFx process, collaboration and cooperation between the soliciting business and a vendor is generally not permitted. Any collaboration and cooperation may be considered as partiality and a sign of favoritism to a particular vendor, thereby jeopardizing the objective nature of the RFx process. Finally, open communication between soliciting business and vendor is typically not possible. Any open communication, which could convey information that other vendors are not necessarily cognizant of, may also be considered as a form of partiality or favoritism toward the vendor that has received information that the other vendors may not know.

Thus, conventional RFx processes, although striving to ensure fairness in communication and opportunity among all vendors, tend to be time-consuming and rigid. A typical RFx process may take many months to develop and consider. In that time period, the original request of the soliciting business may have changed, thereby necessitating a new and/or amended request, which could prolong the RFx process even more. Furthermore, a soliciting business with a request for goods and/or services may not be sophisticated enough to understand what it really needs, and thereby its request for particular goods and/or services may not be a true reflection of the solution(s) to the problems that the business is facing.

### SUMMARY OF THE INVENTION

The present invention is a method of identifying and solving business problems of a given business by taking advantage of a strategic partnership with other businesses that have similar goals as the given business. The given business predetermines which companies are to be designated as strategic partners and allows such companies to receive first-hand knowledge of problems encountered by the given company and its desires for solutions. The strategic partners are therefore in position to not only assist the given business by aiding the business in identifying the true nature of the problem, but also to be able to provide specialized solutions. Such a process of identifying a problem and providing specialized solutions is more economical in terms of time and financial requirements than if the given business had used a conventional RFx process, which could include requests for information, requests for proposals, and requests for quotes. The strategic partner benefits by, for example, receiving a steady stream of potential business.

An exemplary embodiment of the present invention is a method of solving a business problem of a given business. The method includes identifying the business problem of the given business, presenting the business problem to a select group of one or more partners, receiving a solution from one or more partners, discussing at least one received solution with one or more partners, and choosing a final solution that best addresses the business problem of the given business.

Another exemplary embodiment of the present invention is a method of finding a solution to a business problem of a given business. The method includes addressing the problem by a committee that includes the given business and a select group of one or more partners, receiving a solution from one or more partners, discussing one or more received solutions with the select group, and choosing a final solution that addresses the business problem of the given business.

Yet another exemplary embodiment of the present invention is a method of framing a business problem and identifying the best solution to the business problem of a given business. The method includes convening a committee that includes the given business and a select group of one or more partners, identifying the business problem of the given business, receiving a solution from one or more partners, discussing a received solution with one or more partners, and choosing a final solution that best addresses the business problem of the given business.

### BRIEF DESCRIPTION OF THE DRAWINGS

FIG. 1 is a flow diagram of a Request For X (“RFx”) process.

FIG. 2 is a flow diagram of an exemplary embodiment of a method for improving business processes in accordance with the present invention.

FIG. 3 illustrates an exemplary situation wherein a process according to the present invention is more beneficial over a conventional process.

FIG. 4 illustrates an exemplary business environment and the relative position of various businesses with respect to a centrally located soliciting business.

### DETAILED DESCRIPTION OF PREFERRED EMBODIMENTS

Having considered the drawbacks of a conventional RFx process, as described above, the inventors of the present invention have recognized that a need exists for a procedure that streamlines the conventional RFx process in order to save time and resources. Additionally, they have recognized that a need exists for a procedure that enables the soliciting business to glean the benefits of the RFx process without having to devote the time and financial resources required by the RFx process. To present the differences of the present invention over that of conventional procedures, exemplary embodiments of the present invention will be shown as compared to a conventional RFx procedure. The present invention is not limited to the exemplary embodiments shown and described herein and other exemplary embodiments are also possible.

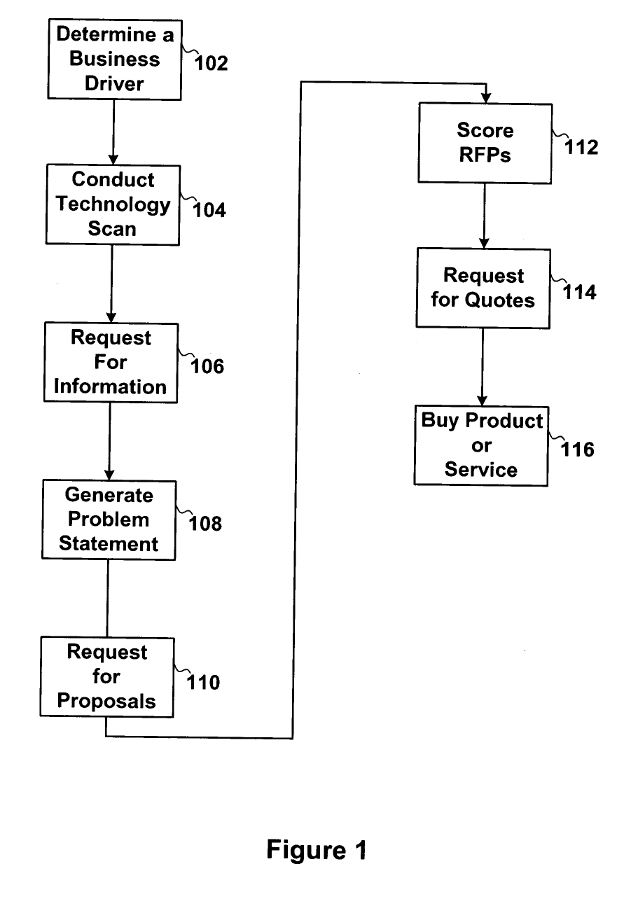

As shown in FIG. 1, a typical business procedure begins with determining a business driver or business need 102. For example, a business may be experiencing problems or inefficiencies with its computer systems. This business problem or inefficiency usually motivates the business to seek a solution. Any such solution could be available from within the business itself and/or through outside vendors that specialize or provide services that address the business problem or inefficiency.

The next step is a technology scan step 104. In this step, the business determines what solutions are currently available in the market and what capabilities are currently possessed in-house by the business itself. If the existing problem can be adequately solved by existing capabilities, then a solution can be implemented without having to consult outside businesses. Having the business determine a business problem, conduct a technology scan, and find a solution without consulting outside businesses tends to be the most economical method of addressing business problems. As a non-limiting example, if a business determines that its computer systems are incapable of communication with each other at a high speed, and the business determines that high speed connectors are available off the shelf that enable high speed communication, then the business could purchase such connectors and install them without seeking the assistance of outside businesses or consultants.

If, however, the soliciting business does not possess the capabilities to solve the problem that it is facing, the business may then solicit other businesses and seek assistance, through, for example, a solicitation via a Request for Information 106. In this step, the soliciting business requests information from outside sources to determine what resources, technologies, and capabilities are currently available to address its particular business problem. If the soliciting business is only seeking to consider possible solutions to a given problem, and vendors are able to inform the soliciting business of various solutions, including technical issues that may have to be considered, then step 106 may be the final step for the soliciting business. However, if the soliciting business seeks to solicit the information in order to determine future actions, then subsequent steps are taken to progress the procedure. Such subsequent steps could typically require the vendors to communicate back to the soliciting business in the form of proposals or price quotes which are usually informative of the issues involved in a solution for the soliciting business, and most often resemble commercial offers in nature.

Using information received as a result of the request for information 106, the soliciting business may then generate a problem statement 108. In this step 108, the soliciting business defines the nature of the problem and particularly specifies the technical needs of the solution to the problem.

The defined problem statement is used by the soliciting business in the next step where the business solicits requests for proposals 110 from interested vendors. In this step 110, the soliciting business announces its desire for interested vendors to submit proposals that would address a given problem of the business. After the proposals have been collected from various vendors according to pre-set rules and conditions, all of the proposals are then analyzed in step 112 to determine objective scores comparing the businesses. In this step 112, the proposals submitted by the vendors are merely evaluated, and generally, no working prototype, model, code, application or device is actually considered. Only each vendor's proposal to the given solicitation of a business problem is considered in determining which one or more of the proposals, if any, are more feasible than others for the soliciting business.

After one or more particular proposals have been selected, the soliciting business may then submit a request for quotes 114 from various vendors for the chosen proposal(s). Interested vendors can then submit price quotes which estimate the cost for completing the solution as outlined in the chosen proposal(s). The soliciting business may then compare the various price quotes submitted by various vendors and choose one or more vendors that present a financially feasible solution. Thus, in step 116, the soliciting business may select a particular vendor for the project. A transaction is then entered into by the soliciting business and the chosen vendor wherein the vendor provides the requested good and/or service and in exchange, the vendor receives consideration.

Although the above described typical RFx process as shown in FIG. 1 has been presented with various steps and in a given order, such an RFx process is not required to have each such step and/or be in such an order. Typically, a soliciting business will combine one or more of the steps in FIG. 1 to save time and costs. For example, steps 110 and 114 may be combined after a problem statement is developed in step 108 such that interested vendors would present both a proposal and a price quote in response to the problem statement. This way, the soliciting business could score each vendor's proposal with the cost already accounted for. Other combinations are also possible. Nevertheless, the RFx procedure still suffers from several drawbacks including time, financial, and information waste which is a byproduct of the rigid back-and-forth characteristic of the typical RFx procedure. The present invention presents a solution to decrease the waste associated with time, financial, and information exchange between a soliciting business and various vendors.

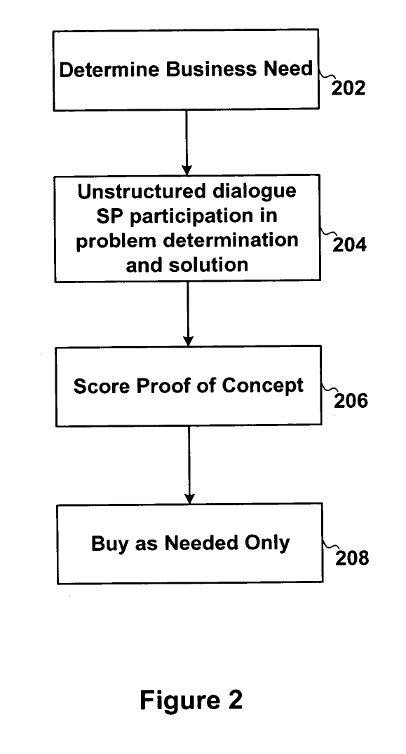

FIG. 2 shows a flow diagram of an exemplary embodiment of a process in accordance with the present invention. The exemplary procedure shown in FIG. 2 generally may be less formal, more collaborative, and more efficient than conventional procedures, such as that shown in FIG. 1. The process shown in FIG. 2 begins in manner similar to the process shown in FIG. 1, in that a first step is directed to recognition of a business need or problem 202 that motivates the business to seek a solution. However, the similarities between the conventional method shown in FIG. 1 and the exemplary embodiment of the present invention shown in FIG. 2 end after this initial step of problem recognition.

As opposed to a conventional RFx procedure as shown in FIG. 1 where direct communication is not generally allowable, a soliciting business following the exemplary procedure shown in FIG. 2 communicates directly and interactively 204 with strategic partners (“SP”), as opposed to vendors in general, in addressing the business problem. SPs may be predetermined in that the soliciting business may form a consortium of businesses that share similar short and long term goals as the soliciting business. For example, the soliciting business may be a large telecommunications company that has research and development (“R & D”) centers that specialize in various diverging areas in the telecommunications field. Each R & D center in the telecommunications company has its own business and technological goals which may be unique. Thus, each center may need to seek potential vendors and contractors that are specially designed or capable of handling the particular needs and interests of the specific center. It may be possible for a vendor to have the expertise or capability of addressing the needs of multiple R & D centers. Such vendors that are deemed to be most in tune with the short and long term goals of the particular R & D center, for example, in technology advancement, may be requested to form a strategic partnership with the soliciting telecommunications company.

An important advantage to a vendor in having been selected for strategic partnership with a soliciting business includes greater access to information from the soliciting company. A chosen SP will be given direct information from the soliciting business in what are the short and/or long term goals of the soliciting business. Further the chosen SP vendor may be able to shape or mold the short and/or long term goals of the soliciting company to better fit the vendor's capabilities. Also, the SP vendor would have the advantage of a relatively frequent supply of potential business projects from the soliciting business.

In return for granting an SP status to a given vendor and all of the privileges and advantages that are associated with it, the soliciting company would also receive a number of advantages from the SP-designated vendor. For example, the soliciting business would not have to develop a comprehensive, time-consuming, and costly RFx process for every business problem for which the soliciting business would need assistance.

Also, if the needs and/or problems of the soliciting business change after the an RFx process is initiated, the soliciting business is not forced to restart the entire RFx process anew with the amended need or problem statement, which typically would be the case using a conventional RFx procedure, as shown with respect to FIG. 1. Using the exemplary embodiment of the present invention as presented in FIG. 2, the soliciting business would merely restate the need or problem to the SP vendor(s) and receive immediate response in the form of information, proposals, or quotes. Much effort, time, and resources can be saved using the exemplary embodiment of the present invention as shown in FIG. 2 over that of a conventional RFx procedure, as shown in FIG. 1.

In practice, the strategic partners and the soliciting business enter into productive dialogue with one another regarding, for example, how to address each of the business needs of the soliciting business provided the goods and/or services that are available from the various SP vendors. It may even be possible for the vendors that are within the SP of a given business to communicate with each other in order to develop joint solutions that benefit multiple vendors.

An SP relationship has another advantage of providing relatively quick feedback and open communication between the soliciting business and SP-designated vendors. Such efficient communication decreases the time required by conventional RFx procedures. To increase time efficiency even more, the strategic partners may further participate in both the determination and definition of the problem, and the determination and development of a comprehensive solution. In certain cases, the problems and solutions may be discussed and determined simultaneously, for example, in a given day, which would save much time and financial resources associated with developing a conventional RFx solution. Thus, exemplary processes according to the given invention are designed to be very fluid and interactive, rather than static and structured. Also, since there is no need to maintain objectivity and impartiality, the soliciting business using a procedure as outlined in FIG. 2 may conduct secret or private communications with one or more of its SP vendors at the exclusion of other partners.

After the dialogue step 204 has been completed, the soliciting business may then score proofs of concept in step 206. In this step 206, the business scores or measures actual proofs of concept, as opposed to proposals used in conventional RFx procedures. These proofs of concept are real world demonstrations by the strategic partners that exhibit their ability to deliver actual working solutions. Measuring or judging proofs of concept, as opposed to proposals, allows the soliciting business to more accurately estimate the eventual cost and the eventual capabilities of the strategic partner's product and/or services.

In practice, step 206 may be eliminated or just merged into step 204. For example, only a given SP vendor may have the capability to provide a particular product and/or service to the soliciting business. Such a given SP vendor may have further proved itself to the soliciting business in the past. Thus, there may not be a need for the SP vendor to further prove its capability to the soliciting business other than to engage in the completion of a transaction involving the product and/or services agreed upon in step 204.

Alternatively, two or more SP vendors may provide different solutions for the business problem developed in step 204. Any one or more SPs that would be interested, financially or strategically, in providing a solution the problem presented would then submit such a solution to the soliciting business (“SB”). After receiving and considering each proposed solutions, the SP would then discuss one or more of the proposed solutions with one or more of its SP vendors in order to get additional feedback regarding the feasibility of each considered solution. After such discussion is made, the SB may choose the best one solution or combination of solutions that would most favorably suit the problem. Other alternatives are also possible.

Finally, in step 208, the soliciting business may enter into an agreement with the strategic partner to deliver the agreed upon goods and/or services. Thus, the procedure from the initial recognition of a business problem in step 202 to the eventual contracting of a solution in step 208 is typically shorter, more efficient, more valuable, and less costly than conventional RFx procedures shown in steps 102-116. Furthermore, the solution using the SP methodology may be distributed among multiple businesses, each contributing to the final solution to the initial business problem.

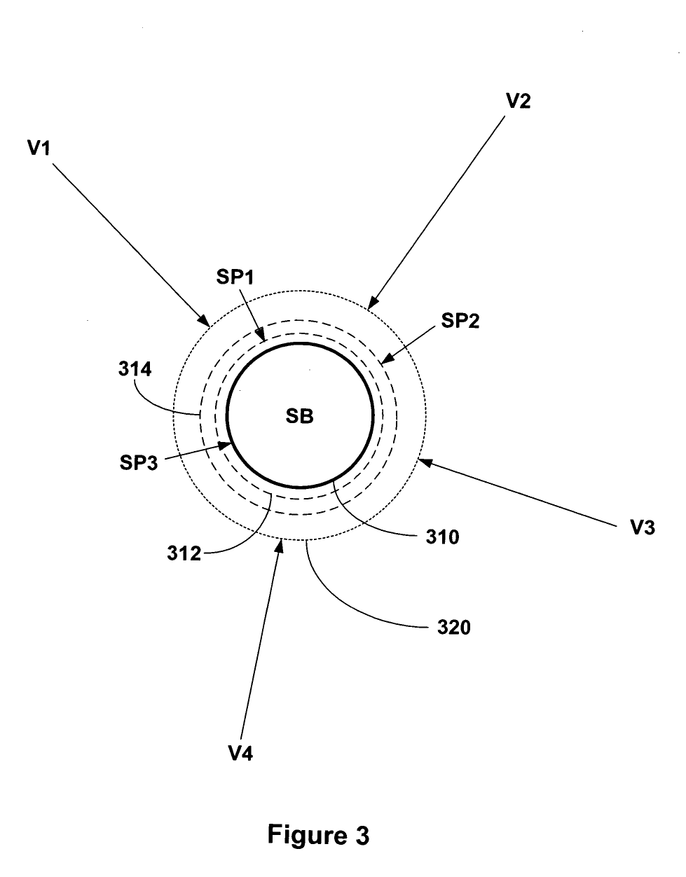

FIG. 3 shows a business process according to another exemplary embodiment of the present invention. In such a business process, a soliciting business SB is faced with a business problem or condition for which the business may benefit from outside assistance. The SB typically will not present the entire nature of the business problem to the outside world for fear of competitors perhaps gleaning information as to the direction of the SB. In this case, “direction” refers to the short and long term goals of the business, whether relating to financial, technological, strategic, or combinations thereof.

Alternatively, the SB may not already know the various potential solutions to its business problem, and may only be capable of representing its problem in a very general manner. In other words, the SB may only recognize that it has a problem, and to be addressed, but not recognizing potential solutions that are available to address this problem. Thus, the SB typically only reveals a general level of information to the public, such as in the form of an RFx. This level of RFx information released to the public is typically a general description of the business SB and a request for assistance from outside vendors to address a generally-described problem. The general level of information provided in the RFx is represented by label 320 in FIG. 3.

Upon learning of the RFx that is prepared by the SB, various vendors, such as V1, V2, V3, and V4, reply to the request of the SB with various solutions. However, each such solution presented by any of the vendors, V1, V2, V3, and V4, is only responsive specifically to the level of information 320 that the SB had originally presented. Thus, the vendors V1, V2, V3, and V4 are each shown with an arrow that represents each particular vendor's solution that only goes so far as to address the problem that has been generally described by the SB, which is at level 320. Vendors V1, V2, V3, and V4 are not made aware of the more specific details of the business problem and/or are incapable of presenting more specialized solution to the problem for various reasons, including the purposeful lack of information released by the SB to maintain a level of confidentiality, a lack of understanding by the SB as to the full nature of the problem and possible solutions, and others.

In any case, any solution presented by any vendors V1, V2, V3, or V4 will only be as good and responsive to an RFx relative to the level 320 of information in the RFx released by the SB. If after the RFx procedure has begun and the SB realizes that the initial disclosure of information or formation of its problem statement was insufficient to fully describe its problem, the SB will likely amend or renew its RFx. Any such amended or renewed RFx most likely restarts or delays the period of response by potential vendors, thereby prolonging the already lengthy period of time that spans from an initial discovery of a problem until eventual contractual negotiation with a given vendor to solve this problem. Thus, a period that may take several months or more, may be lengthened continuously until the problem statement is defined clearly enough to allow vendors to fairly evaluate and bid on solutions to the problem. This delayed period of time elevates the SB's costs in both financial and time resources involved in managing and handling the extended period of delays. Furthermore, if the problem is costly to the SB, then any delayed solution to the problem would continue to be costly to the SB until the problem is remedied.

In contrast, in a strategic partnership scenario, as described above, businesses which are designated as SP by, for example, the SB or other entity having some control over SB, are in a closer relationship with SB, thereby decreasing the toll on time and financial expenses. SP designated businesses SP1, SP2, and SP3 shown in FIG. 3 have been designated or treated as strategic partners of SB. Thus, each SP is privileged to be closer to the operation and needs of the SB. For the same problem scenario described above with respect to SB and V1, V2, V3, and V4, any possible solutions presented by any SPs are more specific to the actual problem presented by SB and require less time to implement. Because each SP gleans information about any potential problems of SB in a timelier fashion and any potential vendor V would, an SP is in position to present a timelier solution to the problem of SB. Furthermore, the SP may be able to suggest more specialized solutions to the problem or even to educate the SB in understanding what is the true nature of the problem.

In any case, open and real time dialog between SB and any or all of its SPs with respect to the nature of the SB problem would not only clarify the true nature of the problem, but also consider different solutions to the problem, and even consider varying costs associated with different solutions. Such discourse between an SB and its SPs could potentially occur in a single day, rather than the many months typically required to run the course of a conventional RFx procedure.

Each strategic partner of a given SB may or may not conduct business in the same field. Thus, there is potential for overlap of products and/or services between the SPs. If there is such overlap, it would create a slightly more competitive environment than if there is no overlap between SPs, but such a situation is still beneficial to the SPs because of the potential of joint ventures or other potential agreements. If each SP has the capability and desire to address a given problem presented by an SB, then each SP could present a possible solution to the SB.

In FIG. 3, the SB has determined that it has a particular business problem for which it seeks solutions. As described above, any RFx that may be used to address this problem would only be beneficial in getting solutions from vendors that address only a hazier outer level 320 solution to the problem. However, each SP with more privileged information relating to the problem presented by SB would be in position to present a solution that is more closer to an ideal solution level. Thus, each SP presents its version of the solution and, if required, its consideration for implementing such a solution. For example, SP1 presents a solution at level 312, SP2 presents a solution at level 314, and SP3 presents a solution at level 310. Evaluating each of the levels of solutions 310, 312, and 314, presented by its strategic partners, SP3, SP1, and SP2, respectively, SB determines that level 310 is the best solution to its problem because, for example, it strikes a proper balance between the specificity of its solution and cost consideration for implementation. Thus, SP3 is chosen to address this SB problem, and implement its solution at level 310.

Comparing the solution received at level 320 by SB by using an RFx procedure to the solution received at level 310 by SB by using a strategic partnership, it is evident that the latter provides the more specialized solution to the problem, in a quicker time period, at a potentially lower cost to SB. Thus, the strategic partnership has benefited the soliciting business in terms of time and resources involved in soliciting information, proposals, and quotes. The strategic partners have also benefited from their association with the soliciting business by having a first-hand view of the problems facing the soliciting business, being able to provide specialized solutions, and having a constant source of potential business. SB could still solicit solutions from businesses outside of its strategic partnerships, but any strategic partner would be incentivized to be more flexible in addressing SB problems and thereby prevent the SB to seek such outside vendors and jeopardize the SP relationship.

Another potential benefit realized by the SB stems from the notion that the amount of potential confidential business matter that may have to be disclosed in a typical RFx to solicit responses from potential vendors may be significant. For example, competitors may glean insights into potential future projects of the SB by considering any RFx that is proposed by the SB. This open access to future projects of a given SB by considering the RFx's of the SB is detrimental to the SB to the level that competitors are indirectly kept informed of future business projects. Thus, another advantage of the above described exemplary embodiments according to the present invention is that competitors are not made aware of potential future projects of the SB because no open RFx are presented to the public.

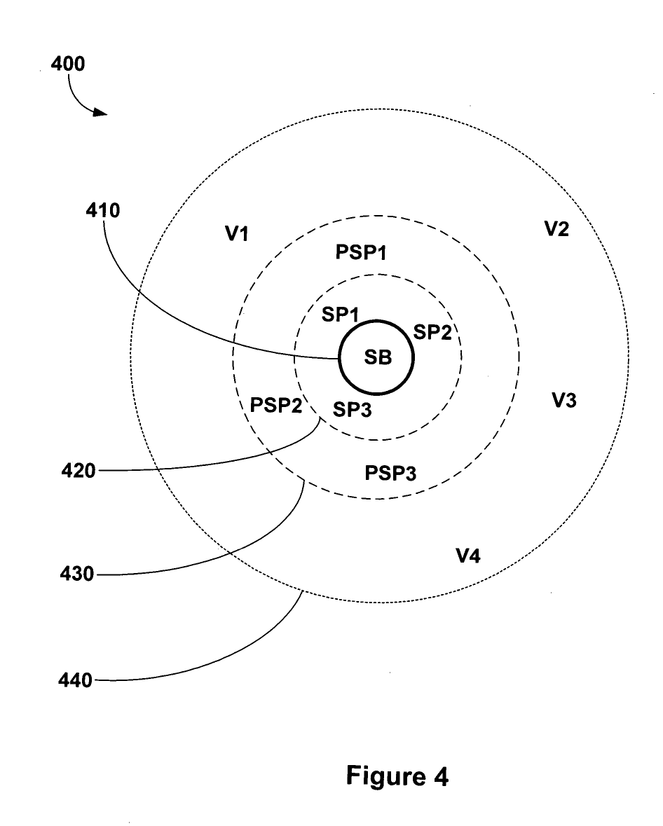

FIG. 4 illustrates the relative positioning of the business universe 400 and its concentric layer of businesses that surround a soliciting business SB. All information that is known by the SB is represented as being contained in the first area 410. Information falling within this area is generally not known outside of the SB. The first layer of businesses outside of area 410 includes any SPs that are associated with the SB. All such SPs are located within area 420 and any such information known within this area is generally privileged only because of the SP designation. Outside area 420 represents potential strategic partners (“PSPs”), which are businesses that the SB has either worked with in the past, trusts, or otherwise may be in position to be introduced into area 420 as SPs. Outside of area 430 represents businesses that have been vendors V for SB or are potential vendors because they offer products and/or services that are applicable to SB's needs. Any vendor V outside of area 430 may become a PSP or SP if the SB recognizes that the vendor V has similar short and long term goals as the SB. Outside of area 440 are all over businesses in the business universe, which include businesses that offer products and/or services that are not directly applicable to the needs of SB. Any business outside of area 440 may enter into area 440 by offering products and/or services that are directly beneficial for SB and fulfill some business need of SB.

In describing representative embodiments of the invention, the specification may have presented the method and/or process of the invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the invention should not be limited to the performance of their steps in the order written, and one skilled in the art can readily appreciate that the sequences may be varied and still remain within the spirit and scope of the invention.

The foregoing disclosure of the embodiments of the invention has been presented for purposes of illustration and description. It is not intended to be exhaustive or to limit the invention to the precise forms disclosed. Many variations and modifications of the embodiments described herein will be obvious to one of ordinary skill in the art in light of the above disclosure. The scope of the invention is to be defined only by the claims appended hereto, and by their equivalents.

What I claim is:

1. A method of solving a business problem of a given business, the method comprising:
identifying the business problem of the given business;
presenting the business problem to a select group of one or more partners;
receiving a solution from the one or more partners;
discussing at least one received solution with the one or more partners; and
choosing a final solution that best addresses the business problem of the given business.

2. The method of claim 1, wherein the select group assists the given business in identifying the problem.

3. The method of claim 1, wherein the select group is predetermined by the given business.

4. The method of claim 3, wherein each partner in the select group is chosen by the given business because of the partner's similar business goals as the given business.

5. The method of claim 3, wherein each partner in the select group engages in a similar business as at least one other partner in the select group.

6. The method of claim 3, wherein each partner in the select group engages in a business that is different than at least one other partner in the select group.

7. The method of claim 1, wherein all of the steps may be performed successfully in a single day.

8. A method of finding a solution to a business problem of a given business, the method comprising:
addressing the problem by a committee that includes the given business and a select group of one or more partners;
receiving a solution from the one or more partners;
discussing one or more received solutions with the select group; and
choosing a final solution that addresses the business problem of the given business.

9. The method of claim 8, wherein the select group assists the given business in identifying the problem.

10. The method of claim 8, wherein the select group is predetermined by the given business.

11. The method of claim 10, wherein each partner in the select group is chosen by the given business because of the partner's similar business goals as the given business.

12. The method of claim 10, wherein each partner in the select group engages in a similar business as at least one other partner in the select group.

13. The method of claim 10, wherein each partner in the select group engages in a business that is different than at least one other partner in the select group.

14. The method of claim 8, wherein all of the steps may be performed successfully in a single day.

15. A method of framing a business problem and identifying the best solution to the business problem of a given business, the method comprising:
convening a committee that includes the given business and a select group of one or more partners;
identifying the business problem of the given business;
receiving a solution from one or more partners;
discussing a received solution with the one or more partners; and
choosing a final solution that best addresses the business problem of the given business.

16. The method of claim 15, wherein the select group is predetermined by the given business.

17. The method of claim 16, wherein each partner in the select group is chosen by the given business because of the partner's similar goals as the given business.

18. The method of claim 16, wherein each partner in the select group engages in a similar business as at least one other partner in the select group.

19. The method of claim 16, wherein each partner in the select group engages in a business that is different than at least one other partner in the select group.

20. The method of claim 15, wherein all of the steps may be performed successfully in a single day.
